(19) United States
(12) Patent Application Publication
(10) Pub. No.: US 2012/0256946 A1
(43) Pub. Date: Oct. 11, 2012

(54) IMAGE PROCESSING APPARATUS, IMAGE PROCESSING METHOD AND PROGRAM

(76) Inventors: Sensaburo Nakamura, Kanagawa (JP); Masayuki Sekiya, Tokyo (JP); Toshimasa Kakihara, Kanagawa (JP)

(21) Appl. No.: 13/432,283

(22) Filed: Mar. 28, 2012

(30) Foreign Application Priority Data
Apr. 6, 2011 (JP) 2011-084847

(51) Int. Cl. G09G 5/00

(52) U.S. Cl. 345/619

(57) ABSTRACT

An element choice list designating a plurality of elements among elements included in CG description data is generated in advance and stored. Examples of the element include a virtual object (CG object), a virtual camera, a virtual light, a virtual force field, and a virtual wind. An image generating unit excludes one or more elements other than an element selected by a user's manipulation from among the elements designated by the element choice list from the CG description data and generates a CG image. By manipulating the selection manipulating unit, the user can perform a manipulation of selecting the element from the element choice list and can easily change content of a CG image.

### BACKGROUND

The present technology relates to an image processing apparatus, an image processing method, and a program. Particularly, the present technology relates to an image processing apparatus suitable when image synthesis is performed by computer graphics (CG).

In the past, for example, techniques of rendering a plurality of CG materials created by a CG producer, storing a rendering result, for example, as a CG image in an MPEG format in a server in advance, and synthesizing a CG image, selected by a user's selection manipulation from among a plurality of CG images stored in the server, with a synthesis target image which is a synthesis target, for example, with an image obtained by capturing an announcer by a camera of a studio have been performed.

For example, Japanese Patent Application Laid-Open No. 11-007549 discloses an apparatus capable of displaying only a part of a graphical display forming a three-dimensional bar graph when an operator performs a manipulation input on a display screen using a mouse and selects a specific location of a display.

Further, for example, Japanese Patent Application Laid-Open No. 2006-330927 discloses a technique of receiving a manipulation input of selecting a part of a shape in a display such as a three-dimensional (3D) computer-aided design (CAD) and then performing a display such that non-selected portions are deleted.

Furthermore, for example, Japanese Patent Application Laid-Open No. 2009-223650 discloses an apparatus that provides a plurality of users with a virtual space and displays an object (virtual object) in the virtual space according to a user attribute. That is, a technique of selecting whether or not an object present in the virtual space is to be displayed according to a user is disclosed.

### SUMMARY

There is a demand for a technique of synthesizing desired CG works sequentially created by a producer, for example, with a broadcast image (for example, a live-action video) while changing the content by a manipulation according to a state of the image.

In the above-mentioned related arts, an object (virtual object) decided by a system in advance can be excluded from a rendering (image generation) target, or an object to be excluded from a rendering target can be designated by a manipulation. However, in the related arts, it has been difficult to select a rendering target by an appropriate method for a created arbitrary CG work.

It is desirable to easily change the content of a CG image and easily generate an image according to an operational situation.

The concept of the present disclosure is an image processing apparatus including a list storage unit that stores an element choice list designating a plurality of elements among elements included in computer graphics (CG) description data, a selection manipulating unit that receives a manipulation of selecting an element from the element choice list, and an image generating unit that generates a CG image based on the CG description data. The image generating unit may exclude one or more elements other than the element selected by the selection manipulating unit from among the plurality of elements designated by the element choice list stored in the list storage unit from the CG description data, and generates a CG image.

In this technology, the list storage unit stores an element choice list designating a plurality of elements among elements included in CG description data. Here, examples of the element include a virtual object (CG object), a virtual camera, a virtual light, a virtual force field, and a virtual wind. The selection manipulating unit receives a manipulation of selecting an element from the element choice list.

The image generating unit generates a CG image based on the CG description data. At this time, the image generating unit excludes one or more elements other than an element selected by the selection manipulating unit from among elements designated by the element choice list stored in the list storage unit from the CG description data, and generates a CG image.

In this case, for example, the image generating unit may include a working storage unit in which the CG description data is developed to be used for image generation, and an update control unit that erases or invalidates, in the working storage unit, one or more elements other than the element selected by the selection manipulating unit from among elements designated by the element choice list stored in the list storage unit. The image generating unit may be configured to generate a CG image based on content of the working storage unit.

In this technology, a CG image is generated by excluding one or more elements other than an element selected by the selection manipulating unit among elements designated by the element choice list stored in the list storage unit from the CG description data. Thus, the content of the CG image can be easily changed, and an image can be easily generated according to an operational situation.

In this technology, for example, the CG description data may include the element in a tree structure, and a list generating unit that receives a manipulation designating a node in the tree structure and generates the element choice list including a plurality of elements present below the node may be further provided. Thus, an element choice list corresponding to an arbitrary CG work can be easily generated while reducing the operator's time and effort of selecting an element.

The concept of the present disclosure is an image processing apparatus including a switcher, a list storage unit that stores an element choice list designating a plurality of elements among elements included in computer graphics (CG) description data, and an image generating unit that generates a CG image based on the CG description data. A specific input bus among a plurality of input buses of the switcher may receive an output of the image generating unit, a button array of an input selection manipulating unit of the switcher may include a plurality of buttons that commonly select the specific input bus and correspond to the plurality of elements designated by the element choice list, respectively, and when any one of the plurality of buttons is pressed, the image generating unit may exclude one or more elements other than an element corresponding to the pressed button from among the elements designated by the element choice list stored in the list storage unit from the CG description data, and generates a CG image.

In this technology, the list storage unit stores an element choice list designating a plurality of elements among elements included in CG description data. The image generating unit generates a CG image based on the CG description data.

Here, among a plurality of input buses of the switcher, a specific input bus receives an output of the image generating unit. A button array of an input selection manipulating unit of the switcher includes a plurality of buttons that commonly select the specific input bus and correspond to the plurality of elements designated by the element choice list, respectively.

When any one of the plurality of buttons is pressed, the image generating unit excludes one or more elements other than an element corresponding to the pressed button from among the elements designated by the element choice list stored in the list storage unit from the CG description data, and generates a CG image. Thus, by using the button array of the input selection manipulating unit of the switcher, the content of the CG image can be easily changed, and an image can be easily generated according to an operational situation.

According to the embodiments of the technology described above, the content of a CG image can be easily changed, and an image can be easily generated according to an operational situation.

### BRIEF DESCRIPTION OF THE DRAWINGS

FIG. 1 is a block diagram illustrating a configuration example of an image processing apparatus according to an embodiment of the technology;

FIG. 2 is a diagram illustrating a concrete configuration example of an image generating unit and an image mapping unit;

FIG. 3 is a diagram illustrating a configuration example of functional blocks of an image generating unit and an image mapping unit;

FIG. 4 is a flowchart illustrating an example of a processing procedure of a load process of loading CG description data and an element choice list in an image generating unit;

FIG. 5 is a flowchart illustrating an example of a processing procedure of a generating process of generating a CG image in an image generating unit;

FIG. 6 is a diagram illustrating an example of a GUI for generating an element choice list;

FIG. 7 is a diagram illustrating an example of a GUI before a GUI for generating an element choice list is opened;

FIG. 8 is a diagram illustrating an example of a GUI for generating an element choice list using a tree structure display;

FIG. 9 is a diagram illustrating an example of a GUI for generating an element choice list using a tree structure display;

FIG. 10 is a diagram illustrating a state in which “Box001,” “Polygon2,” “StringM1,” and “StringM2” are selected as elements;

FIG. 11 is a flowchart schematically illustrating an element setting procedure when a derived information editing unit generates an element choice list;

FIG. 12 is a flowchart illustrating an example of a processing procedure of an image generating process by an image generating unit when an element choice list (file) including a plurality of elements as a choice is used;

FIG. 13 is a diagram illustrating a state in which “name” of an element choice list is “Selection1” and a node “Group2” is selected;

FIG. 14 is a flowchart schematically illustrating a setting procedure of a parent node when a derived information editing unit generates an element choice list;

FIG. 15 is a flowchart illustrating an example of a processing procedure of an image generating process by an image generating unit when an element choice list (file) including a parent node as a choice is used; and

FIG. 16 is diagrams illustrating examples of a content change pattern of a CG image.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted. Hereinafter, embodiments of embodying the technology (hereinafter referred to as “embodiments”) will be described. The description will be given in the following order:

1. Embodiment

2. Modified Example

### 1. Embodiment

[Configuration of Image Processing Apparatus]

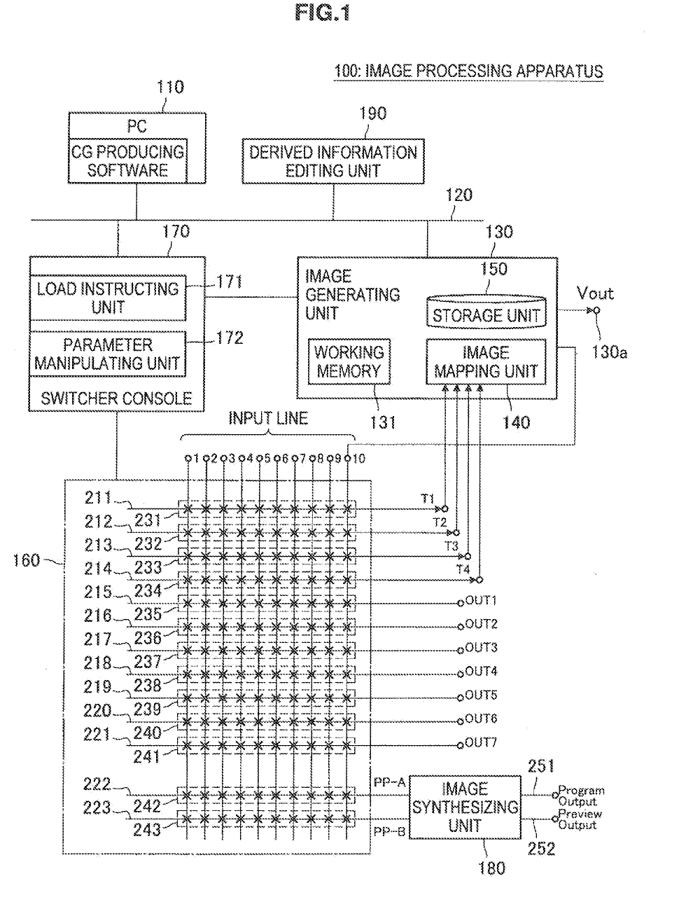

FIG. 1 illustrates a configuration example of an image processing apparatus 100 according, to an embodiment of the technology. The image processing apparatus 100 includes a CG producing unit 110, a network 120, an image generating unit 130, an image mapping unit 140, and a storage unit 150.

Further, the image processing apparatus 100 includes a matrix switch 160, a switcher console (image selection manipulating unit) 170, an image synthesizing unit (program/preview mixer) 180, and a derived information editing unit 190. The CG producing unit 110, the image generating unit 130, the switcher console 170, and the derived information editing unit 190 are connected to the network 120.

The CG producing unit 110 is configured with a personal computer (PC) including CG producing software. The CG producing unit 110 outputs CG description data of a predetermined format. For example, an exemplary format of the CG description data is Collada (registered trademark). Collada is a description definition to achieve an exchange of 3D CG data on extensible markup language (XML). For example, the following information is described in the CG description data.

(a) Definition of Material (Surface Aspect) A definition of “material” refers to the quality of the surface of a CG object (how it looks). The definition of the material contains information on color, reflection method, light emission, unevenness or the like. The definition of the material may contain information on texture mapping. Texture mapping is a technique to paste an image to a CG object, and a complex shape can be expressed while relatively reducing a load of a processing system.

(b) Definition of Geometric Information “Geometry”

A definition of geometric information “Geometry” contains information on position coordinates and vertex coordinates about a polygon mesh.

(c) Definition of Camera

A definition of “camera” contains parameters of a camera.

(d) Definition of Animation

A definition of “animation” contains various information in each key frame of an animation. For example, the definition of the animation contains information on time in each key frame of the animation. The various information refers to information such as a time of a key frame point of a corresponding object (node), position and vertex coordinate values, the size, a tangent vector, an interpolation method, and a change in various information in an animation.

(e) Position, Direction, Size, Definition of Corresponding Geometric Information, and Definition of Corresponding Material of Node (Object) in Scene

These kinds of information are not dispersive but are associated with one another, for example, as follows:
Node . . . geometric information
Node . . . materials (plural)
Geometric information . . . polygon sets (plural)
Polygon set . . . material (one of materials corresponding to node)
Animation . . . node

A description configuring a single screen is called a scene. Each definition is called a library and is referred to by a scene. For example, when there are two rectangular parallelepiped objects, each rectangular parallelepiped object is described as one node, and one of the material definitions is associated with one node. As a result, the material definition is associated with each rectangular parallelepiped object, and rendering is performed based on color or reflection characteristics according to each material definition.

Alternatively, when the rectangular parallelepiped object is described by a plurality of polygon sets and the polygon sets are associated with the material definitions, different polygon sets are rendered by different material definitions. For example, although the rectangular parallelepiped object has six sides, the rectangular parallelepiped object may be described by three polygon sets such that three sides are described by one polygon set, one side is described by one polygon set, and two sides are described by one polygon set. Since different polygon sets are associated with different material definitions, different sides can be rendered in different-colors.

When texture mapping is designated in the material definition, an image based on image data is texture-mapped to an associated side of the object.

For example, a setting may be made so that an image can be texture-mapped to the material definition. Thus, the same image can be texture-mapped to all sides of the rectangular parallelepiped object, and different images can be texture-mapped to different sides.

The matrix switch 160 selectively extracts an image (image data) from among a plurality of input images (input image data). In this embodiment, the matrix switch 160 includes 10 input lines, 13 output bus lines 211 to 223, and 13 cross point switch groups 231 to 243. The matrix switch 160 configures a part of an effect switcher. The matrix switch 160 is used to supply the image mapping unit 140 as an external device with image data and to supply the internal image synthesizing unit 180 or the like with image data.

The output bus lines 211 to 214 are bus lines for supplying the image mapping unit 140 with image data. The output bus lines 215 to 221 are bus lines for outputting image data to the outside. The output bus lines 222 and 223 are bus lines for supplying the internal image synthesizing unit 180 with image data.

The 10 input lines are arranged in one direction (a vertical direction in FIG. 1). Image data is input to the input lines “1” to “9” from a video tape recorder (VTR), a video camera, or the like. CG image data output from the image generating unit 130 is input to the input line “10.” The 13 output bus lines 211 to 223 intersect the input lines and are arranged in another direction (a horizontal direction in FIG. 1).

The cross point switch groups 231 to 234 perform connection operations at cross points at which the 10 input lines intersect the output bus lines 211 to 214, respectively. Based on the user's image selection manipulation, connection operations of the cross point switch groups 231 to 234 are controlled, and any of image data input to the 10 input lines is selectively output to the output bus lines 211 to 214. The output bus lines 211 to 214 configure output lines T1 to T4 that output image data for texture mapping (mapping input).

The cross point switch groups 235 to 241 perform connection operations at cross points at which the 10 input lines intersect the output bus lines 215 to 221, respectively. Based on the user's image selection manipulation, the cross point switch groups 235 to 241 are controlled, and any of image data input to the 10 input lines is selectively output to the output bus lines 215 to 221. The output bus lines 215 to 221 configure output lines OUT1 to OUT7 that output image data for external output.

The cross point switch groups 242 and 243 perform connection operations at cross points at which the 10 input lines intersect the output bus lines 222 and 223, respectively. Based on the user's image selection manipulation, the cross point switch groups 242 and 243 are controlled, and any of image data input to the 10 input lines is selectively output to the output bus lines 222 and 223.

An on/off operation of the cross point switches of the cross point switch groups 231 to 243 causes image data including consecutive frame data to be switched and thus is performed within a vertical blanking interval (VBI), which is an interval between frames.

Image data output to the output bus lines 222 and 223 is input to the image synthesizing unit (program/preview mixer) 180. The image synthesizing unit 180 performs a process of synthesizing image data input from the output bus lines 222 and 223. A program (PGM) output is output to the outside from the image synthesizing unit 180 via a program output line 251. A preview output is output to the outside from the image synthesizing unit 180 via a preview output line 252.

In this embodiment, the derived information editing unit 190 functions as a list generating unit, and generates an element choice list designating a plurality of elements from among elements included in CG description data generated by the CG producing unit 110 based on the CG description data. A plurality of elements designated by the element choice list include, but are not limited thereto, elements of the same kind. Examples of the kind of element include a virtual object (CG object), a virtual camera, a virtual light, a virtual force field, and a virtual wind. The derived information editing unit 190 may generate an arbitrary number of element choice lists on each of a plurality of CG description data created by the CG producing unit 110. The details of the element choice list generated by the derived information editing unit 190 will be described later.

The image generating unit 130 generates a CG image which is a 3D virtual space image based on CG description data created by the CG producing unit 110 and the element choice list corresponding to the CG description data. The storage unit 150 stores a certain number of CG description data and the element choice lists respectively corresponding to the respective CG description data. For example, the storage unit 150 is configured with a hard disk or the like. A storage location of the CG description data and the element choice list is not limited to the inside of the image generating unit 130 and may be any other location, for example, any other storage location connected to the network 120.

In this embodiment, the CG description data created by the CG producing unit 110 is transmitted to the image generating unit 130 via the network 120 and then stored in the storage unit 150. The element choice list generated by the derived information editing unit 190 is transmitted to the image generating unit 130 via the network 120 and then stored in the storage unit 150 in association with the CG description data.

The image generating unit 130 reads the element choice list, which is instructed from a load instructing unit 171 installed in the switcher console 170, from the storage unit 150, and reads the CG description data corresponding to the element choice list from the storage unit 150. The image generating unit 130 develops the read CG description data in a working memory 131 configuring a working storage unit so as to use the read CG description data for image generation.

The image generating unit 130 recognizes an element selected from among a plurality of elements designated by the read element choice list based on a parameter (control value) decided by a selection manipulation made in a parameter manipulating unit 172 installed in the switcher console 170. The image generating unit 130 erases or invalidates one or more elements other than the selected element among the plurality of elements designated by the read element choice list in the working memory 131 and excludes the erased or invalidated element from a rendering target.

The image generating unit 130 generates a CG image based on the content of the working memory 131. Thus, the CG image is basically based on a CG image by the CG description data developed in the working memory 131, however, a part of the CG image is changed corresponding to an element selected from among a plurality of elements designated by the element choice list. In other words, the content of the CG image generated by the image generating unit 130 is changed by the selection manipulation made in the parameter manipulating unit 172.

For example, the image generating unit 130 performs rendering on a polygon set present in geometric information of a certain node by designating a color of the polygon set and the like with reference to the geometric information and the associated material definition. In the case of an animation, rendering is performed such that a current time progresses in units of frames, and a value of a previous key frame and a value of a next key frame are decided by performing an interpolation between the values.

For example, the image generating unit 130 controls the image mapping unit 140 such that an image based on a mapping input forming a pair with each attribute value (name) present in an image allocation table (not shown) is texture-mapped to the surface of a polygon associated with the attribute value.

The image mapping unit 140 performs texture mapping under control of the image generating unit 130. For example, an attribute is a material, and, for example, an image allocation table is a table in which a material name is associated with an image input number (a number designating one of T1 to T4 in FIG. 1).

For example, the image mapping unit 140 may be mounted to be integrated with the image generating unit 130 and may be implemented by control by software on a central processing unit (CPU) and an operation by hardware such as a graphics processing unit (GPU). The control software designates a polygon set to be texture-mapped and instructs the designated polygon set to the hardware.

[Configuration Example of Image Generating Unit and Image Mapping Unit]

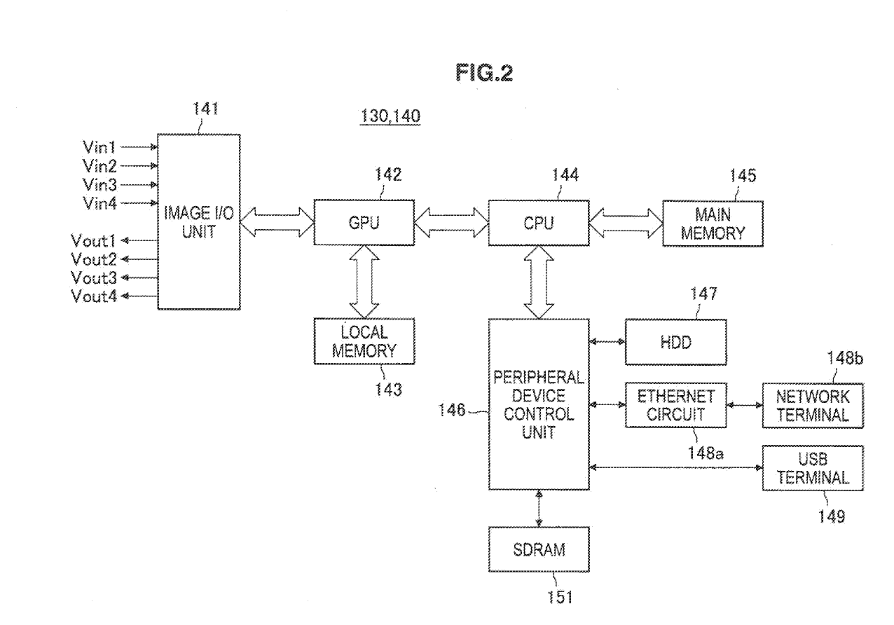

FIG. 2 illustrates a concrete configuration example of the image generating unit 130 and the image mapping unit 140. The image generating unit 130 and the image mapping unit 140 include an image input/output (I/O) unit 141, a GPU 142, a local memory 143, a CPU 144, and a main memory 145. The image generating unit 130 and the image mapping unit 140 further include a peripheral device control unit 146, a hard disk drive (HDD) 147, an Ethernet circuit 148a, and a network terminal 148b. The image generating unit 130 and the image mapping unit 140 further include a universal serial bus (USB) terminal 149 and a synchronous dynamic random access memory (SDRAM) 151. Here, “Ethernet” is a registered trademark.

The image I/O unit 141 receives image data to be texture-mapped, and outputs image data of a CG image to which an image based on the image data is appropriately texture-mapped. The image I/O unit 141 can receive image data of a maximum of four systems and can also output image data of a maximum of four systems. For example, image data handled here may be image data conforming to a high definition television-serial digital interface (HD-SDI) standard specified in SMPTE292M. The GPU 142 and the main memory 145 are configured to be able to equally access the image I/O unit 141.

The main memory 145 functions as a working area of the CPU 144 and temporarily stores image data input from the image I/O unit 141. The CPU 144 entirely controls the image generating unit 130 and the image mapping unit 140. The CPU 144 is connected with the peripheral device control unit 146. The peripheral device control unit 146 performs an interface process between the CPU 144 and a peripheral device.

The CPU 144 is connected with a built-in HDD 147 via the peripheral device control unit 146. Further, the CPU 144 is connected with the network terminal 148b via the peripheral device control unit 146 and the Ethernet circuit 148a. The CPU 144 is connected with the USB terminal 149 via the peripheral device control unit 146. Furthermore, the CPU 144 is connected to the SDRAM 151 via the peripheral device control unit 146.

The CPU 144 controls texture coordinates. In other words, the CPU 144 performs a process of texture-mapping an image based on input image data to the surface of a polygon to be rendered by the GPU 142 on the input image data. The GPU 142 generates a CG image based on CG description data stored in the HDD 147 or the like, and texture-maps an image to the surface of a designated polygon as necessary. The local memory 143 functions as a working area of the GPU 142 and temporarily stores image data of the CG image created by the GPU 142.

The CPU 144 can access the local memory 143 as well as the main memory 145. Likewise, the GPU 142 can access the local memory 143 and the main memory 145. The CG image data, which has been generated by the GPU 142 and then primarily stored in the local memory 143, is sequentially read from the local memory 143 and output from the image I/O unit 141.

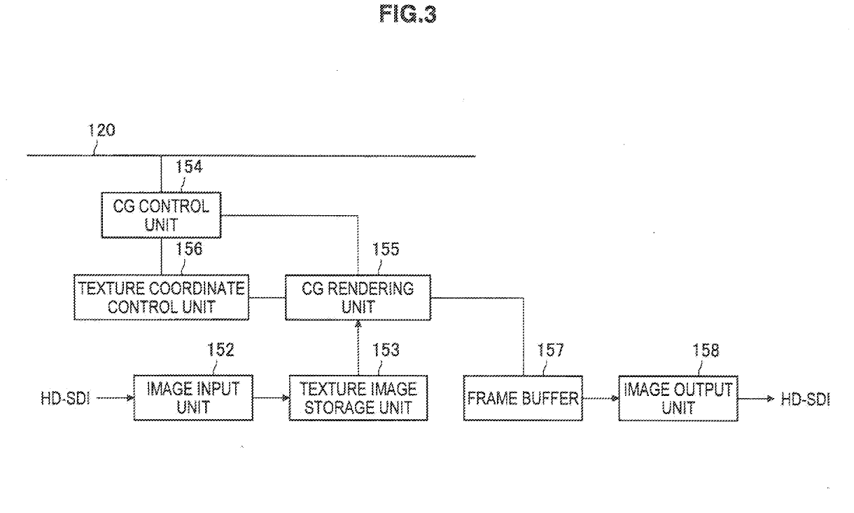

FIG. 3 illustrates a configuration example of functional blocks of the image generating unit 130 and the image mapping unit 140. The image generating unit 130 and the image mapping unit 140 include functional blocks such as an image input unit 152, a texture image storage unit 153, a CG control unit 154, a CG rendering unit 155, a texture coordinate control unit 156, a frame buffer 157, and an image output unit 158.

The image input unit 152 and the image output unit 158 are implemented by the image I/O unit 141. The texture image storage unit 153 is implemented by the main memory 145. The CG control unit 154 and the texture coordinate control unit 156 are implemented by the CPU 144. The CG rendering unit 155 is implemented by the GPU 142. The frame buffer 157 is implemented by the local memory 143.

The image input-unit 152 and the texture image storage unit 153 form a pair. The number of image input systems can be increased by increasing the number of pairs of the image input unit 152 and the texture image storage unit 153. The frame buffer 157 and the image output unit 158 form a pair. The number of image output systems can be increased by increasing the number of pairs of the frame buffer 157 and the image output unit 158.

The switcher console 170 receives a manipulation input of an instruction to the matrix switch 160. The switcher console 170 includes a button array for manipulating on/off operations of the switches of the cross point switch groups of the matrix switch 160.

The switcher console 170 includes the load instructing unit 171 and the parameter manipulating unit 172. The load instructing unit 171 instructs the image generating unit 130 to use an element choice list (a file including an element choice list) in response to the user's manipulation. As described above, the image generating unit 130 reads the instructed element choice list from the storage unit 150 and performs a load process of reading CG description data corresponding to the element choice list.

The parameter manipulating unit 172 decides a parameter (control value) for selecting an element from among a plurality of elements designated by the element choice list in response to the user's manipulation, and transmits the decided parameter to the image generating unit 130. The parameter manipulating unit 172 includes a specified number of adjusting knobs (not shown). A value of the parameter (the control value) for selecting an element from among a plurality of elements designated by the element choice list is decided by an adjusting knob corresponding to the element choice list. As described above, the image generating unit 130 controls rendering by selecting an element from among a plurality of elements designated by the read element choice list based on the parameter. That is, the image generating unit 130 generates a CG image by excluding one or more elements other than a selected element from among a plurality of elements designated by the element choice list from the CG description data.

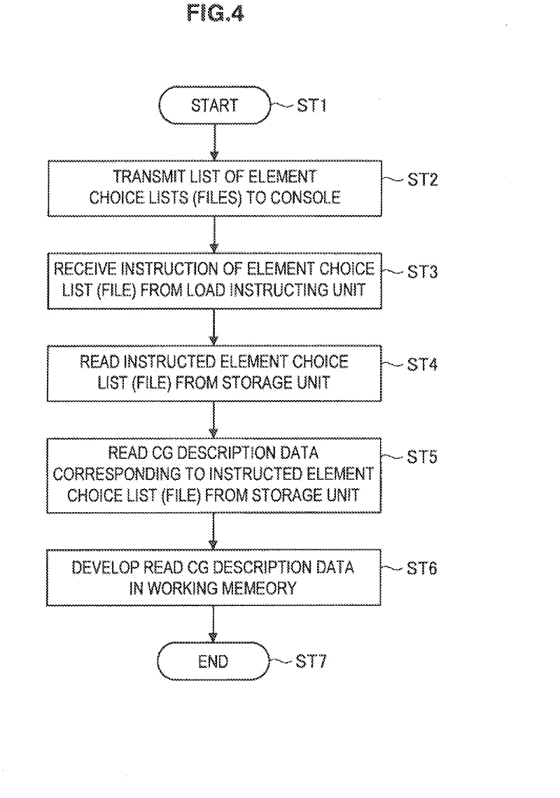

A flowchart of FIG. 4 illustrates an example of a processing procedure of a load process of loading CG description data and an element choice list in the image generating unit 130. In step ST1, the image generating unit 130 starts the load process, and thereafter, the process proceeds to step ST2. In step ST2, the image generating unit 130 transmits a list of element choice lists (files) stored in the storage unit 150 to the switcher console 170. As described above, a plurality of CG description data are stored in the storage unit 150. For example, the list transmitted to the switcher console 170 is the list of the element choice lists (files) corresponding to CG description data previously selected by a user.

Next, the image generating unit 130 receives an instruction of the element choice list (file) from the load instructing unit 171 of the switcher console 170. The switcher console 170 causes the list of the element choice lists (files) transmitted from the image generating unit 130 to be displayed on a display unit. Further, the switcher console 170 selects the element choice list (file) to be used for image generation in the image generating unit 130, and instructs the image generating unit 130 to use the selected element choice list (file). In this case, the switcher console 170 can select one or more element choice lists (files).

Next, in step ST4, the image generating unit 130 reads the instructed element choice list (file) from the storage unit 150, and stores the read element choice list (file) in a main memory (not shown). In step ST5, the image generating unit 130 reads CG description data corresponding to the instructed element choice list (file) from the storage unit 150, and stores the read element choice list (file) in the main memory (not shown).

Next, in step ST6, the image generating unit 130 develops the CG description data read in step ST5 in the working memory 131 so as to use the CG description data for generation of an image. After step ST6, in step ST7, the image generating unit 130 ends the load process. As a result, the image generating unit 130 enters a state capable of generating a CG image using the CG description data and the element choice list.

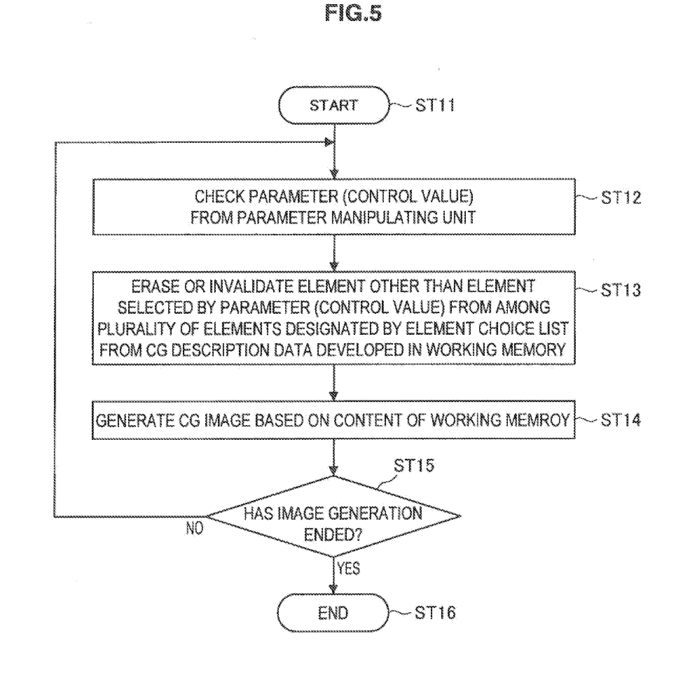

A flowchart of FIG. 5 illustrates an example of a processing procedure of a generating process of generating a CG image in the image generating unit 130. In step ST11, the image generating unit 130 starts an image generating process, and thereafter, the process proceeds to step ST12. In step ST12, the image generating unit 130 checks a parameter (control value) transmitted from the parameter manipulating unit 172 of the switcher console 170.

Next, in step ST13, the image generating unit 130 erases or invalidates one or more elements other than an element selected by the parameter (the control value) among a plurality of elements designated by the element choice list from the CG description, data developed in the working memory 131. Then, in step ST14, the image generating unit 130 generates a CG image of a current frame (field) based on the content of the working memory 131.

Next, in step ST15, the image generating unit 130 determines whether or not image generation has ended. For example, the end of the image generation in the image generating unit 130 may be instructed by operating the switcher console 170 by the user. When it is determined that the image generation has ended, in step S16, the image generating unit 130 ends the image generating process. However, when it is determined that the image generation has not ended, the process returns to step S12, and the image generating unit 130 starts a process for generating a CG image of a next frame (field).

At this time, when the parameter (the control value) from the parameter manipulating unit 172 of the switcher console 170 is changed, the element erased or invalidated from the CG description data developed in the working memory 131 in step ST13 is also changed. Thus, a part of the CG image generated in step ST14 is changed. As a result, by changing the parameter (the control value) from the parameter manipulating unit 172 of the switcher console 170 by the user, the content of the CG image generated by the image generating unit 130 can be timely changed.

[Element Choice List]

An element choice list generated by the derived information editing unit 190 will be described. In the following, examples in which an element is a “virtual object (CG object),” a “virtual camera,” a “virtual light,” a “virtual force field,” and a “virtual wind” will be sequentially described.

(A) Element=“Virtual Object (CG Object)”

Here, a description will be made in connection with an example in which an element is a “virtual object (CG object).” The CG description data includes a description of a virtual object (an instance of a three-dimensional shape such as a polyhedron configured with a polygon) arranged in a virtual space. In this case, a plurality of virtual objects described in the CG description data are listed in the element choice list.

The derived information editing unit 190 has a function of displaying a list of virtual objects, arranged in a virtual space, in loaded CG description data on a graphical user interface (GUI). An operator is allowed to select two or more virtual objects from the list of the displayed virtual objects. For example, a GUI is configured such that when each row of a list display is clicked, a display is reversed and becomes a selected state, and then, when “OK” is selected on all of these, a plurality of virtual objects in the selected state are decided as choices.

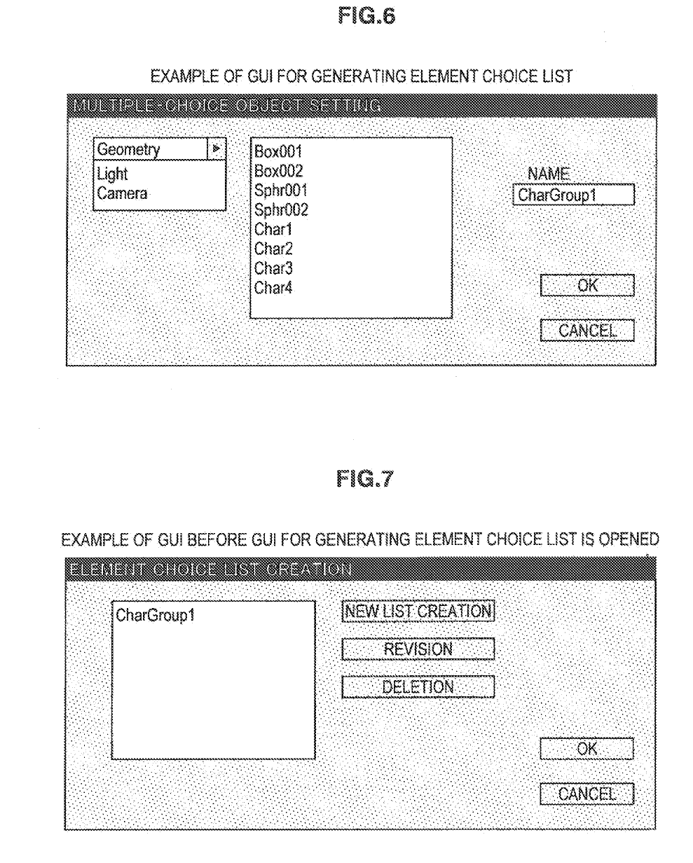

FIG. 6 illustrates an example of a GUI for generating an element choice list. The GUI may be used to generate not only an element choice list of virtual objects (Geometry) but also element choice lists of virtual lights (Light) and virtual cameras (Camera). The kind of element may be selected through the GUI. “Name” refers to a name of an element choice list. When there are a plurality of element choice lists, the element choice lists are identified by names, respectively. FIG. 7 illustrates an example of a GUI before a GUI for generating an element choice list is opened, and a new list creation function, a revising function, and a deleting function are provided.

In the GUI illustrated in FIG. 6, when virtual objects of Char1, Char2, Char3, and Char4 are selected, a generated element choice list has the following contents:

### Name: CharGroup1

### List:

Char1

Char2

Char3

Char4

For example, a part of a Flavor file (a file having correspondence/association information with CG description data in units in which an edit target of the derived information editing unit 190 such as an element choice list is held), which is expressed by pieces of XML, configured such that a designation “modifier_{—}01” of an adjusting knob in the parameter manipulating unit 172 is added to this information, is as follows:

```
<modifierid=“modifier_01” name=“CharGroup1”type=“choice”>
  <choice>
  <item node_id=“”>0</item> <!-- none -->
  <item node_id=“Char01”>1</item>
  <item node_id=“Char02”>2</item>
  <item node_id=“Char03”>3</item>
  <item node_id=“Char04”>4</item>
  </choice>
</modifier>
```

As described above, the parameter manipulating unit 172 is provided with an adjusting knob for deciding a parameter (control value) for selecting an element from among a plurality of elements designated by an element choice list. The adjusting knob functions as a selection manipulating unit that receives a manipulation of selecting an element in an element choice list. The adjusting knob has a structure of changing a value of a parameter when an operator rotates the adjusting knob.

As described above, the parameter manipulating unit 172 is provided with a plurality of adjusting knobs. Any one of a plurality of adjusting knobs is designated by a numerical value designated by id description (end) such as id=“modifier_{—}01”. For example, “modifier_{—}01” designates a first adjusting knob, and “modifier_{—}03” designates a third adjusting knob. An adjusting knob (number) may be allocated to each element choice list through designation by a GUI (not shown). In the above described Flavor file, when a parameter is “0,” the fact that nothing is selected is represented using a null character string “ ”.

Further, in the Flavor file, when the parameter is “1,” “2,” “3,” and “4,” it describes that virtual objects having names of “Char01,” “Char02,” “Char03,” and “Char04” are selected, respectively. The image generating unit 130 performs rendering, using only a selected polygon as a rendering target. That is, the image generating unit 130 generates a CG image by excluding one or more polygons in the choices other than a selected polygon from a rendering target.

In the above description, when the parameter is “0,” it means that nothing is selected. However, when the parameter has any other value, it may mean that nothing is selected. For example, when the parameter ranges from “1” to “5” and the parameter is “5,” it means that nothing is selected. In this case, the following form is desirable.

```
<modifierid=“modifier_01” name=“CharGroup1.”type=“choice”>
  <choice>
  <item node_id=“Char01”>1</item>
  <item node_id=“Char02”>2</item>
  <item node_id=“Char03”>3</item>
  <item node_id=“Char04”>4</item>
  <item node_id=“”>5</item> <!-- none -->
  </choice>
</modifier>
```

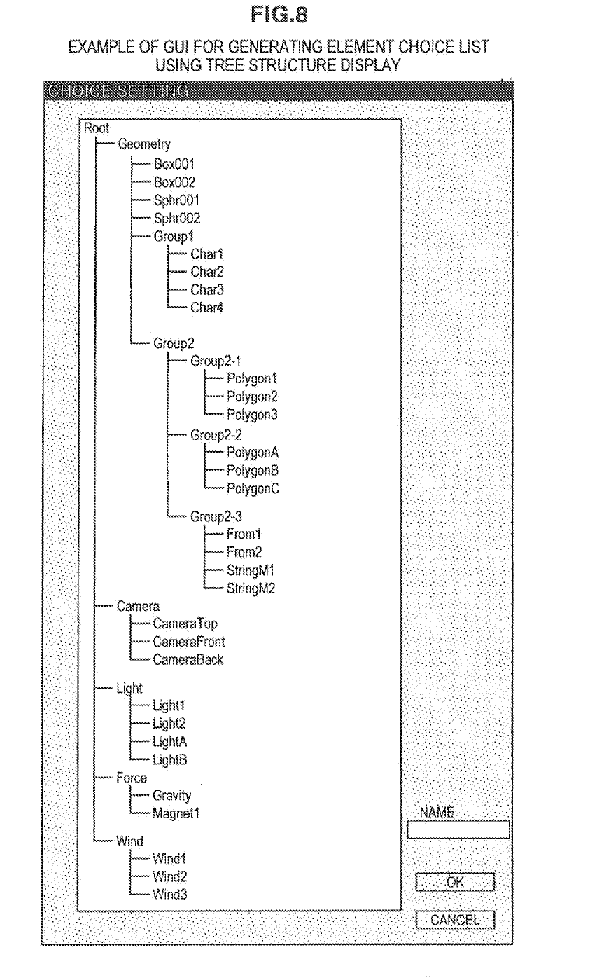

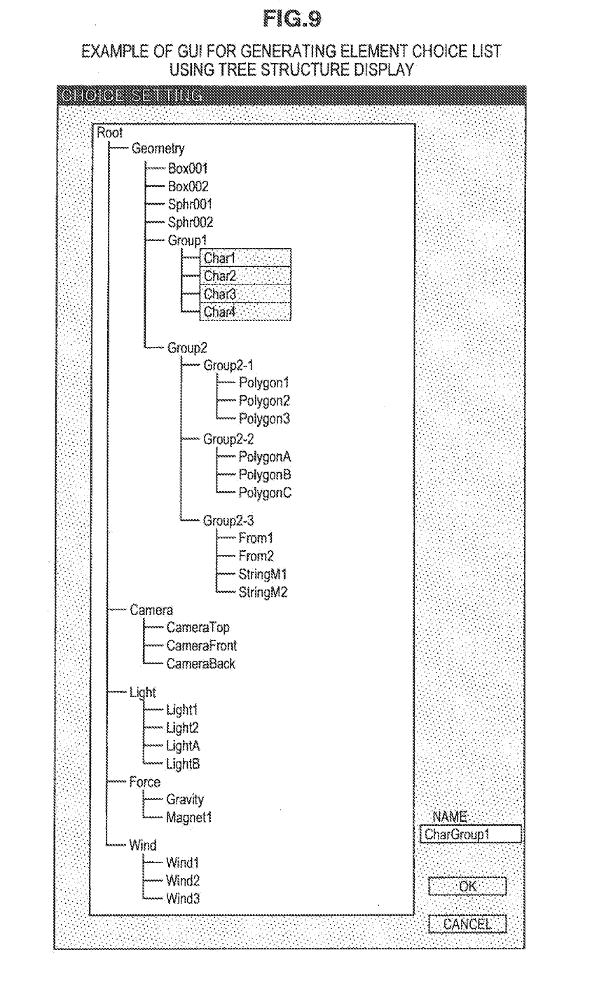

The derived information editing unit 190 may cause CG elements to be displayed in the form of a tree structure in CG and allow an operator to select a choice. FIGS. 8 and 9 illustrate examples of GUIs for generating an element choice list using a tree structure display. FIG. 8 illustrates a state before an element is selected, and FIG. 9 illustrates a state in which “Char01,” “Char02,” “Char03,” and “Char04” are selected as elements.

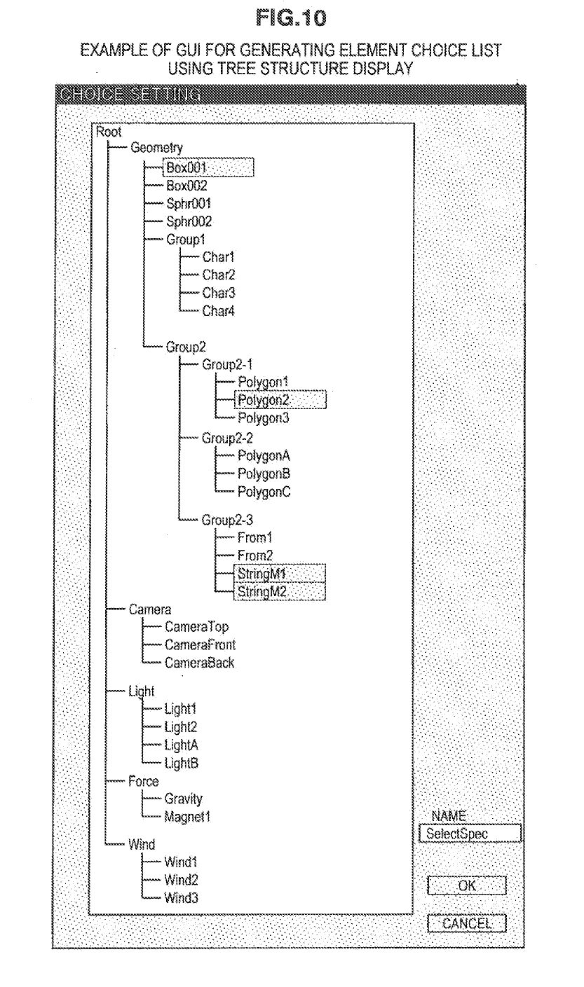

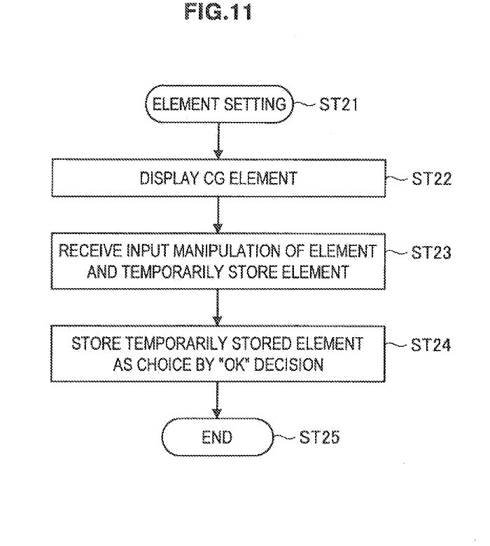

FIG. 10 illustrates a state in which “Box001,” “Polygon2,” “StringM1,” and “StringM2” are selected as elements. In this case, the generated element choice list has the following content.

### Name: SelectSpec

### List:

Box001

Polygon2

StringM1

StringM2

For example, a part of a Flavor file, which is expressed by pieces of XML, configured such that a designation “modifier_{—}09” of an adjusting knob in the parameter manipulating unit 172 is added to this information is as follows:

```
<modifier id=“modifier_09”name=“SelectSpec” type=“choice”>
          <choice>
          <item node_id=“”>0</item> <!-- none -->
          <item node_id=“Box001”>1</item>
          <item node_id=“Polygon2”>2</item>
          <item node_id=“StringM1”>3</item>
          <item node_id=“StringM2”>4</item>
          </choice>
        </modifier>
```

In the above example of generating the element choice list, a value of a parameter is associated with a display order. However, a setting unit (GUI) for editing a correspondence between a value of a parameter and a corresponding choice may be provided.

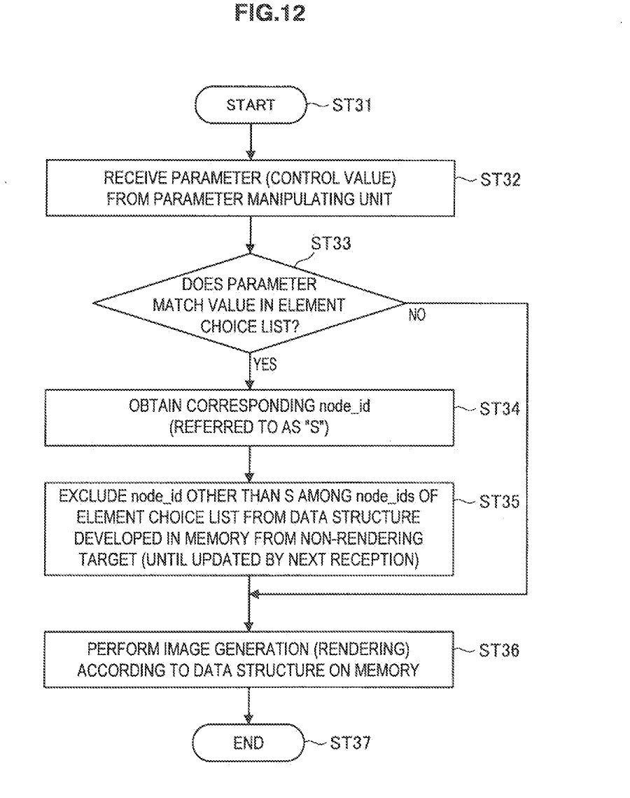

A flowchart of FIG. 11 schematically illustrates an element setting procedure when the derived information editing unit 190 generates an element choice list. This example represents a process when the derived information editing unit 190 receives an input manipulation of an element which is a choice from an operator as described above.

In step ST21, the derived information editing unit 190 starts the process, and thereafter, the process proceeds to step ST22. In step ST22, the derived information editing unit 190 causes a CG element to be displayed on a display unit. In step ST23, the derived information editing unit 190 receives an input manipulation of an element from the operator (see FIGS. 4, 7, and 8) and temporarily stores the element. Thereafter, in step ST24, the derived information editing unit 190 stores the temporarily stored element as a choice in response to a decision made when the operator manipulates an “OK” button. In step ST25, the derived information editing unit ends the process.

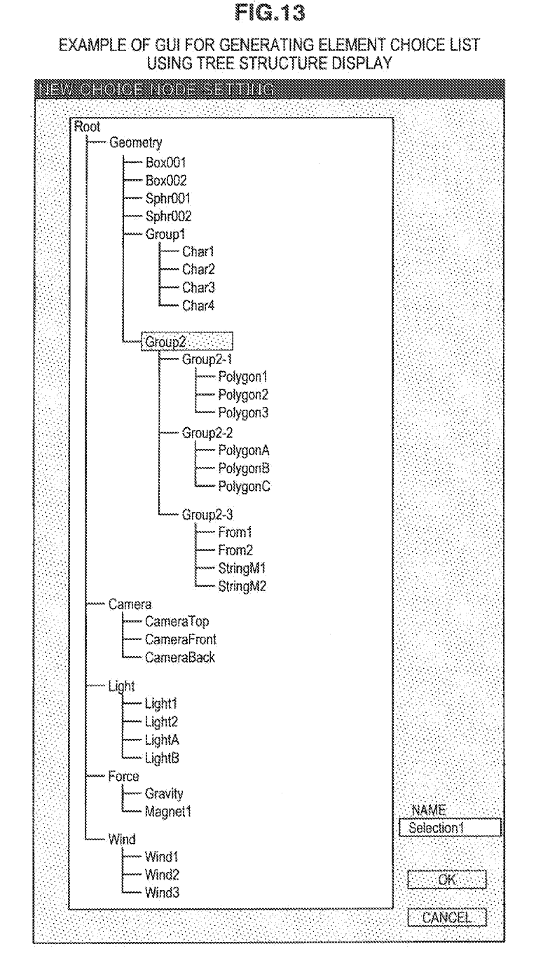

A flowchart of FIG. 12 illustrates an example of a processing procedure of an image generating process of each frame (field) by the image generating unit 130 when an element choice list (file) including a plurality of elements as a choice is used.

In step ST31, the image generating unit 130 starts the process, and thereafter, the process proceeds to step ST32. In step ST32, the image generating unit 130 receives the parameter (control value) from the parameter manipulating unit 172 of the switcher console 170.

Next, in step ST33, the image generating unit 130 determines whether or not the parameter (control value) matches a value in the element choice list (file). When it is determined that the parameter (control value) matches the value in the element choice list (file), in step ST34, the image generating unit 130 obtains a corresponding “node_id” (referred to as “S”).

Then, in step ST35, the image generating unit 130 erases or invalidates one or more “node_id”s other than “S” among “node_id”s of the element choice list from the structure of the CG description data developed in the working memory 131, and excludes the erased or invalidated “node_id”s from the rendering target. This state is continued until the parameter (control value) from the parameter manipulating unit 172 of the switcher console 170 is changed.

Next, in step ST36, the image generating unit 130 generates a CG image of a current frame (field) according to a data structure on the working memory 131. Thereafter, in step ST37, the image generating unit 130 ends the process.

[Use of Tree Structure]

Next, a description will be made in connection with an example in which a node in a tree is written in a choice list using a tree structure.

### (1) Example 1

When a node in a tree is selected and a decision manipulation is performed, a node directly below the selected node, that is, all nodes of a layer directly below the selected node, are written in an element choice list. Even though each of the written nodes is a node (group) other than a leaf node, each node (an overall group) may be one of choices. In this case, the number of times that the user performs a selection manipulation can be reduced, and the element choice list corresponding to an arbitrary CG work can be easily generated.

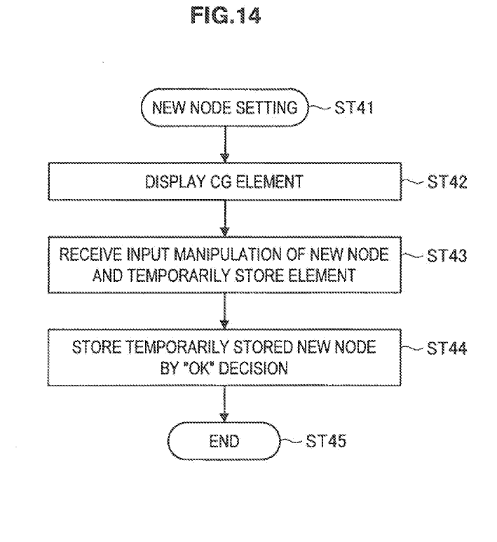

FIG. 13 illustrates a state in which “name” of an element choice list is “Selection1” and a node “Group2” is selected. The element choice list is decided by an “OK” manipulation. In this case, “Group2-1,” “Group2-2,” and “Group2-3,” which are nodes (groups) directly below the node “Group2,” are written in the element choice list. In this case, the generated element choice list has the following content.

### Name: Selection 1

### List:

Group2-1

Group2-2

Group2-3

For example, a part of a Flavor file, which is expressed by pieces of XML, configured such that a designation “modifier_{—}03” of an adjusting knob in the parameter manipulating unit 172 is added to this information through a GUI (not shown) is as follows:

```
<modifierid=“modifier_03” name=“Selection1”type=“choice”>
  <choice>
  <item node_id=“”>0</item> <!-- none -->
  <item node_id=“Group2-1”>1</item>
  <item node_id=“Group2-2”>2</item>
  <item node_id=“Group2-3”>3</item>
  </choice>
</modifier>
```

In this Flavor file, when the parameter is “0,” the fact that nothing is selected is represented using a null character string “ ”. Further, in the Flavor file, when the parameter is “1,” “2,” and “3,” it describes that groups having names of “Group2-1,” “Group2-2,” and “Group2-3” are selected, respectively.

The image generating unit 130 performs rendering using only a polygon included in a selected group as a rendering target. In other words, the image generating unit 130 generates a CG image by excluding one or more polygons included in one or more groups other than a selected group from the rendering target. For example, when the parameter by the adjusting knob is “2,” all polygons belonging to “Group2-1” and all polygons belonging to “Group2-3” are excluded from the rendering target. In this case, however, all polygons belonging to “Group2-2” are consequentially rendered and then included in an output image.

### (2) Example 2

When a node in a tree is selected and a decision manipulation is performed, the node is written in an element choice list. As illustrated in FIG. 13, when “name” is “Selection 1” and a node “Group2” is selected, “Group2” is written in the element choice list as a choice parent node. In this case, the generated element choice list has the following content.

### Name: Selection1

Choice parent node: Group2

For example, a part of a Flavor file, which is expressed by pieces of XML, configured such that a designation “modifier_{—}04” of an adjusting knob in the parameter manipulating unit 172 is added to this information is as follows:

```
<modifierid=“modifier_04” name=“Selection1”type=“choice”>
  <choiceparent=“Group2”>
  <item node_id=“”>0</item> <!-- none -->
  </choice>
</modifier>
```

Further, when the parameter (control value) is set to “0” by the adjusting knob, an item “item” represents that nothing is selected using a null character string “ ”. The image generating unit 130 generates a CG image by the same operation as in “Example 1.” Here, a fourth adjusting knob is used as the adjusting knob.

In this case, “Group2-1,” “Group2-2,” and “Group2-3” are not listed. For this reason, for example, nodes that are associated with parameters (control values) of the adjusting knobs may be associated with 1, 2, 3, and the like, respectively, in alphabetical order of node names. For example, by causing a character string to be displayed on the adjusting knob side and displaying a node selected at each point in time when a manipulation is made, operability is improved.

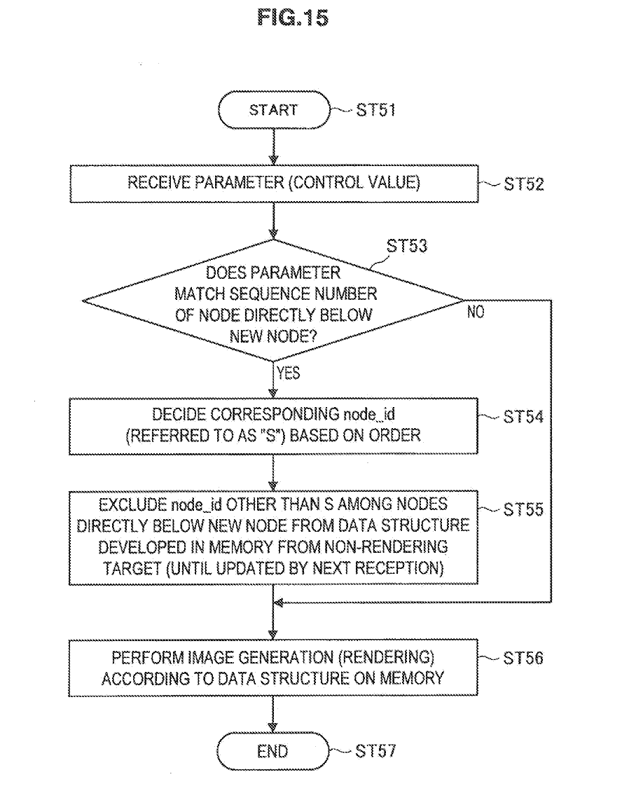

A flowchart of FIG. 14 schematically illustrates a setting procedure of a parent node when the derived information editing unit 190 generates an element choice list. This example represents a procedure when the derived information editing unit 190 receives an input manipulation of a parent node which becomes a choice from the operator as described above.

In step ST41, the derived information editing unit 190 starts the process, and thereafter, the process proceeds to step ST42. In step ST42, the derived information editing unit 190 causes a CG element to be displayed on a display unit. In step ST43, the derived information editing unit 190 receives an input manipulation of a parent node by the operator (see FIG. 13) and temporarily stores the element. Thereafter, in step ST44, the derived information editing unit 190 stores the temporarily stored parent node as a choice in response to a decision made when the operator manipulates an “OK” button. Then, in step ST45, the derived information editing unit 190 ends the process.

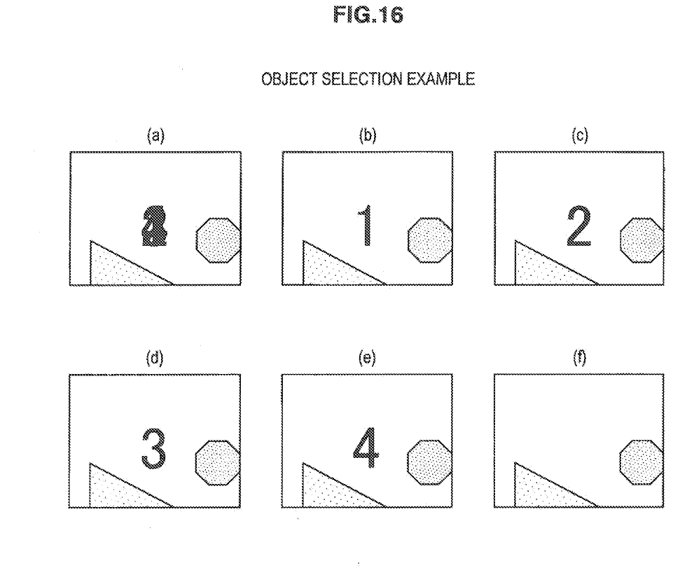

A flowchart of FIG. 15 illustrates an example of a processing procedure of an image generating process of each frame (field) by the image generating unit 130 when an element choice list (file) including a parent node as a choice is used.

In step ST51, the image generating unit 130 starts the process, and thereafter, the process proceeds to step ST52. In step ST52, the image generating unit 130 receives the parameter (control value) from the parameter manipulating unit 172 of the switcher console 170.

Next, in step ST53, the image generating unit 130 determines whether or not the parameter (control value) matches a sequence number of a node directly below a parent node. When it is determined that the parameter (control value) matches the sequence number of the node directly below the parent node, in step ST54, the image generating unit 130 decides a corresponding “node_id” (referred to as “S”).

Then, in step ST55, the image generating unit 130 erases or invalidates one or more “node_id”s other than “S” among “node_id”s of the parent node from the structure of the CG description data developed in the working memory 131, and excludes the erased or invalidated “node_id”s from the rendering target. This state is continued until the parameter (control value) from the parameter manipulating unit 172 of the switcher console 170 is changed.

Next, in step ST56, the image generating unit 130 generates a CG image of a current frame (field) according to a data structure on the working memory 131. Thereafter, in step ST57, the image generating unit 130 ends the process.

(B) Element=“Virtual Camera”

A description will be made in connection with an example in which an element is a “virtual camera.” In FIG. 8, a choice is set on nodes below a node “Camera” in the same way as the manipulation on the object (polygon/virtual object).

The image generating unit 130 generates a CG image using a virtual camera having a number selected by the adjusting knob at the time of image generation. It is rare for “camera” to have a hierarchical structure. Since one camera is typically used for rendering; by making a setting of associating the adjusting knob with “virtual camera,” one of all virtual cameras in CG description data may be selected by manipulating the adjusting knob. Even cases other than “camera” may be automatically decided as a choice using this method.

When “name” is “Cameras” and “CameraTop,” “CameraFront,” and “CameraBack” are selected, a generated element choice list has the following content.

### Name: Cameras

### List:

CameraTop

CameraFront

CameraBack

For example, a part of a Flavor file, which is expressed by pieces of XML, configured such that a designation “modifier_{—}05” of an adjusting knob in the parameter manipulating unit 172 is added to this information is as follows:

```
<modifierid=“modifier_05” name=“Cameras” type=“choice”>
  <choice>
  <item node_id=“”>0</item> <!-- none -->
  <item node_id=“CameraTop”>1</item>
  <item node_id=“CameraFront”>2</item>
  <item node_id=“CameraBack”>3</item>
  </choice>
</modifier>
```

When the parameter (control value) is set to “0” by the adjusting knob, the fact that nothing is selected is represented using a null character string “ ”. However, in this case, a virtual camera, which is prepared as a default setting value by the image generating unit 130, rather than a camera included in CG description data, is used. Further, by selecting a node “Cameras” in a tree, the node may be written in an element choice list as a choice parent node. In this case, the generated element choice list has the following content.

### Name: Selection1

Choice parent node: Cameras

For example, a part of a Flavor file, which is expressed by pieces of XML, configured such that a designation “modifier_{—}04” of an adjusting knob in the parameter manipulating unit 172 is added to this information is as follows:

```
<modifierid=“modifier_04” name=“Selection1”type=“choice”>
  <choiceparent=“Cameras”>
  </choice>
</modifier>
```

(C) Element=“Virtual Light”

A description will be made in connection with an example in which an element is a “virtual light.” In FIG. 8, a choice is set on nodes below a node “Light” in the same way as the manipulation on the object (polygon/virtual object).

The image generating unit 130 generates a CG image using a virtual light having a number selected by the adjusting knob at the time of image generation. In otherwords, an image is generated such that one or more virtual lights in the choices other than a virtual light having a number selected by the adjusting knob are not subjected to an image generating process.

When “name” is “LightAB” and “LightA” and “LightB” are selected, a generated element choice list has the following content.

### Name: LightAB

### List:

LightA

LightB

For example, a part of a Flavor file, which is expressed by pieces of XML, configured such that a designation “modifier_{—}06” of an adjusting knob in the parameter manipulating unit 172 is added to this information is as follows:

```
<modifier id=“modifier_06”name=“LightAB” type=“choice”>
          <choice>
          <item node_id=“”>0</item> <!-- none -->
          <item node_id=“LightA”>1</item>
          <item node_id=“LightB”>2</item>
          </choice>
        </modifier>
```

(D) Element=“Virtual Force Field”

A description will be made in connection with an example in which an element is a “virtual force field.” A “force field” defines, for example, gravity in a virtual space (which is the same even in magnetic force or the like). This “force field” is defined by a lower limit, a direction, and strength (acceleration). In the case of magnetic force, the position of a generation source (magnet) is designated, and processing is performed so that magnetic force works as force which is inversely proportional to a square root of the distance from the generation source.

For example, in a scene in which an aerial battle of fighters is drawn, by defining two kinds of gravity directions (vertical directions), including the two kinds of gravity directions in CG data, and selecting either of the gravity directions, images that differ in rendering (image generation) by physical simulation are generated. In CG animation, there is a timeline/animation in which two or more key frame points are defined on a time axis (time line), and a progression is made by interpolating between the two or more key frame points. On the other hand, physical simulation refers to simulation as to how a virtual space changes when an initial state and a condition are set and then a time progresses.

In FIG. 8, a choice is set on nodes below a node “Force” in the same way as the manipulation on the object (polygon/virtual object). The image generating unit 130 performs the same process as in the case of the object at the time of image generation. In this case, it means a change in a parameter used in physical simulation.

When the position (coordinates) of a virtual object is set as another parameter (an adjustment target parameter different from a selecting function from an element choice list), an image may be generated while changing the position of the virtual object upon receiving a manipulation from the parameter manipulating unit 172. At this time, when physical simulation is set, for example, the change in the position of the virtual object by the parameter manipulating unit 172 is processed to be a relative action, and physical simulation progresses as a time progresses during that time. For example, a certain virtual object may move by a manipulation while falling.

When “name” is “ForceSelect” and “Gravity” and “Magnet1” are selected, a generated element choice list has the following content.

### Name: ForceSelect

### List:

Gravity

Magnet1

For example, a part of a Flavor file, which is expressed by pieces of XML, configured such that a designation “modifier_{—}07” of an adjusting knob in the parameter manipulating unit 172 is added to this information is as follows:

```
<modifier id=“modifier_07”name=“ForceSelect” type=“choice”>
          <choice>
          <item node_id=“”>0</item> <!-- none -->
          <item node_id=“Gravity”>1</item>
          <item node_id=“Magnet1”>2</item>
          </choice>
        </modifier>
```

(E) Element=“Virtual Wind”

A description will be made in connection with an example in which an element is a “virtual wind.” By including a plurality of wind definitions in CG description data and selecting any one of the wind definitions, images that differ in rendering (image generation) by physical simulation are generated.

In FIG. 8, a choice is set on nodes below a node “Wind” in the same way as the manipulation on the object. The image generating unit 130 performs the same process as in the case of the object at the time of image generation. For example, an effect that a direction of wind is suddenly changed in midstream can be obtained by rotating the adjusting knob at the time of rendering (image generation) of a scene.

When “name” is “WindSelect” and “Wind1,” “Wind2,” and “Wind3” are selected, a generated element choice list has the following content.

### Name: WindSelect

### List:

Wind1

Wind2

Wind3

For example, a part of a Flavor file, which is expressed by pieces of XML, configured such that a designation “modifier_{—}08” of an adjusting knob in the parameter manipulating unit 172 is added to this information is as follows:

```
<modifier id=“modifier_08”name=“WindSelect” type=“choice”>
          <choice>
          <item node_id=“”>0</item> <!-- none -->
          <item node_id=“Wind1”>1</item>
          <item node_id=“Wind2”>2</item>
          <item node_id=“Wind3”>3</item>
          </choice>
        </modifier>
```

[Operation of Image Processing Apparatus]

An operation related to CG image generation by the image processing apparatus 100 illustrated in FIG. 1 will be briefly described. The CG producing unit 110 generates CG description data for generating a certain CG image through CG producing software. The CG description data generated by the CG producing unit 110 is transmitted to the image generating unit 130 via the network 120 and then stored in the storage unit 150.

The derived information editing unit 190 generates an element choice list designating a plurality of elements among elements included in the CG description data based on the CG description data generated by the CG producing unit 110. For example, the plurality of elements designated by the element choice list are elements of the same kinds. Examples of the kind of the element include a virtual object (CG object), a virtual camera, a virtual light, a virtual force field, and a virtual wind.

The derived information editing unit 190 generates (an arbitrary number of Flavor files including) an arbitrary number of element choice lists on each of a plurality of CG description data generated by the CG producing unit 110. As described above, the element choice list (file) generated by the derived information editing unit 190 is transmitted to the image generating unit 130 via the network 120 and then stored in the storage unit 150.

The load instructing unit 171 of the switcher console 170 instructs the image generating unit 130 to use all element choice lists (files) via the network 120 in response to the user's manipulation. As a result, the image generating unit 130 performs the load process for generating a CG image. That is, the image generating unit 130 reads a certain number of element choice lists instructed by a Flavor file from the storage unit 150 and then reads the CG description data corresponding to the element choice lists from a storage unit. Then, the read CG description data is developed in the working memory 131 for image generation.

After the load process, the image generating unit 130 performs the image generating process. The image generating unit 130 generates a CG image based on the content of the working memory 131. The parameter manipulating unit 172 decides the parameter (control value) for selecting an element from among a plurality of elements designated by the element choice list in response to the user's manipulation on the adjusting knob, and transmits the decided parameter (control value) to the image generating unit 130 via the network 120.

The image generating unit 130 selects an element from among a plurality of elements designated by the read element choice list based on the parameter (control value). Then, the image generating unit 130 erases or invalidates one or more elements other than the selected element among a plurality of elements designated by the read element choice list in the working memory 131 and excludes the erased or invalidated elements from the rendering target.

The CG image generated by the image generating unit 130 is basically based on the CG description data developed in the working memory 131. However, the content of the working memory 131 changes according to the element selected from among a plurality of elements designated by the element choice list. That is, the content of the CG image generated by the image generating unit 130 changes according to the parameter (control value) transmitted from the parameter manipulating unit 172 of the switcher console 170. In this case, by using a plurality of element choice lists in a parallel way, the number of patterns of the content change of the CG image increases.

FIGS. 16A to 16F illustrate examples of content change patterns of a CG image. In this example, numeral objects of “1” to “4” rendered at the same position are included in an element choice list. When rendering is performed based on CG description data without using selection by an element choice list, rendering is performed in a state in which numeral objects of “1” to “4” overlap one another at the same position as illustrated in FIG. 16A.

When selection by the element choice list is used, rendering can be performed, for example, as illustrated in FIGS. 16B to 16F. For example, FIGS. 16B to 16E illustrate rendering examples in which one of the numeral objects of “1” to “4” is selected by the parameters (control values) by the adjusting knobs of the parameter manipulating unit 172, respectively. Further, FIG. 16F illustrates a rendering example in which none of the numeral objects of “1” to “4” is selected by the parameters (control values) by the adjusting knobs of the parameter manipulating unit 172.

As described above, in the image processing apparatus 100 illustrated in FIG. 1, the image generating unit 130 changes a part of a CG image using an element choice list when a CG image is generated based on CG description data. That is, a CG image is generated such that one or more elements other than an element selected by the parameter (control value) from the parameter manipulating unit 172 among elements designated by an element choice list are excluded from CG description data. For this reason, the content of the CG image can be easily changed by the user's manipulation, and image generation can be performed according to an operational situation.

In this technology, there is an effect capable of replacing (selecting from a choice) a confined part on “created CG” under simple manipulation circumstances. Further, in this technology, works are divided into three steps of “production of CG,” “preparation: decision of choice,” and “operation: image generation,” and thus operability at the time of operation and an added value of an image can be maximized.

### 2. Modified Example

The above embodiment has been described in connection with the example in which an element is selected from a plurality of elements designated by the element choice list such that the parameter (control value) is decided by manipulating the adjusting knob configuring the parameter manipulating unit 172 of the switcher console 170. However, a configuration of selecting an element from a plurality of elements designated by an element choice list by using a button array of an input selection manipulating unit of the switcher of the switcher console 170 may be considered.

The switcher is provided with a cross point (switch) which is a unit for switching an input image and receives a manipulation made by cross point buttons which are a push button array of a multiple-choice type. As illustrated in FIG. 1, a switcher system is configured such that an output of the image generating unit 130 is received by a specific input bus among a plurality of input buses. When the input is selected by a cross point button of a certain bus of the switcher, a CG image is supplied from the bus to a previous circuit, for example, an image synthesizing unit.

The cross point button may function as the selection manipulating unit for selecting an element from a plurality of elements designated by the element choice list. Although not shown, the cross point buttons are arranged in the switcher console 170. Typically, for example, first to 20^{th} cross point buttons are set to correspond to first to 20^{th} switcher input image signals.

On the other hand, in order to cause the cross point button to function as the selection manipulating unit, for example, when an output of the image generating unit 130 is transmitted to a fifth switcher input image signal, fifth to ninth cross point buttons are set to correspond to fifth to ninth switcher input image signals. Then, the fifth to ninth cross point buttons also function as the selection manipulating unit.

TABLE 1

| Cross Point Button No. | Input Image Signal No. | Modifier Value |
|---|---|---|
| 1 | 1 | NA |
| 2 | 2 | NA |
| 3 | 3 | NA |
| 4 | 4 | NA |
| 5 | 5 | 0 |
| 6 | 5 | 1 |
| 7 | 5 | 2 |
| 8 | 5 | 3 |
| 9 | 5 | 4 |
| 10 | 6 | NA |
| 11 | 7 | NA |
| 12 | 8 | NA |
| 13 | 9 | NA |
| 14 | 10 | NA |
| 15 | 11 | NA |
| 16 | 12 | NA |
| 17 | 13 | NA |
| 18 | 14 | NA |
| 19 | 15 | NA |
| 20 | 16 | NA |

That is, as shown in Table 1, when a cross point button is pushed and there is a corresponding “modifier value,” the switcher console 170 transmits the “modifier value” to the image generating unit 130 as a parameter so as to use the “modifier value” for control of selecting an element.

As a result, a plurality of image signals which have been originally included in the same CG description data but became different images can be selected with the same manipulation feeling as when different images (signal sources) are selected by the cross point buttons in the related art. A CG image can be selected by a familiar manipulation without changing an operational manipulation of the related art.

Preferably, it may be considered that after the “modifier value” is transmitted to the image generating unit 130, a delay is made until the “modifier value” is reflected to the output image. In this case, control may be performed such that the corresponding input image signal (the fifth input image signal in the above described example) is selected by the cross point circuit after the delay. Thus, it is possible to prevent an image in which the “modifier value” is not reflected from being instantly displayed when a manipulation is made in a state in which any other input image signal is selected.

Alternatively, as another example, one of keyers of an M/E bank may be set to exclusively deal with a CG image. In this case, for example, only a cross point button array of an input bus of the keyer may be set not to perform a function of selecting an input image signal but to have a function of manipulation-inputting a “modifier value” as the selection manipulating unit.

As a setting of the keyer, a setting of selecting whether a normal operation (an operation in related art) is performed on a cross point button or an operation of selecting a specific input image signal receiving an output of the image generating unit 130 and designating a “modifier value” by a cross point button is performed is made.

Then, when the operation of the latter is set, for example, a correspondence relation between each cross point button and a “modifier value” is displayed or set again as shown in Table 2. A range capable of acquiring a “modifier value” differs according to circumstances (the content of Flavor), however, control by a manipulation of a button having a value exceeding the range may be set as ignorable control.

TABLE 2

| Cross Point Button No. | Modifier Value |
|---|---|
| 1 | 0 |
| 2 | 1 |
| 3 | 2 |
| 4 | 3 |
| 5 | 4 |
| 6 | 5 |
| 7 | 6 |
| 8 | 7 |
| 9 | 8 |
| 10 | 9 |

Further, as described above, the content of the element choice list may be prepared in advance at the time of production of CG. For example, when all virtual objects of 0 to 9 having a shape of a single-digit number are arranged at the same position at the time of production and an element choice list is produced so that one number can be selected from the single-digit numbers 0 to 9, CG of an arbitrary single-digit number is obtained. When two or more single-digit numbers are combined, a CG image of a multi-digit number is obtained.

In a part of the following Flavor file, “Char1” to “Char0” correspond to polygons having shapes of 1 to 9 and 0 arranged at a ones place position, respectively. Further, “Char10” to “Char00” correspond to polygons having shapes of 1 to 9 and 0 arranged at a tenths place position.

```
<modifierid=“modifier_01” name=“Digit1” type=“choice”>
  <choice>
  <item node_id=“”>0</item> <!-- none -->
  <item node_id=“Char1”>1</item>
  <item node_id=“Char2”>2</item>
  <item node_id=“Char3”>3</item>
  <item node_id=“Char4”>4</item>
  <item node_id=“Char5”>5</item>
  <item node_id=“Char6”>6</item>
  <item node_id=“Char7”>7</item>
  <item node_id=“Char8”>8</item>
  <item node_id=“Char9”>9</item>
  <itemnode_id=“Char0”>10</item>
  </choice>
</modifier>
<modifierid=“modifier_02” name=“Digit10” type=“choice”>
  <choice>
  <item node_id=“”>0</item> <!-- none -->
  <item node_id=“Char10”>1</item>
  <item node_id=“Char20”>2</item>
  <item node_id=“Char30”>3</item>
  <item node_id=“Char40”>4</item>
  <item node_id=“Char50”>5</item>
  <item node_id=“Char60”>6</item>
  <item node_id=“Char70”>7</item>
  <item node_id=“Char80”>8</item>
  <item node_id=“Char90”>9</item>
  <item node_id=“Char00”>10</item>
  </choice>
</modifier>
```

Alternatively, the selection may not be prepared at the time of CG production. For example, when a CG work including three vehicles is obtained, a manipulation of producing only one of them as an image may be performed (a vehicle has a complicated shape and is a combination of many polygons, however, since nodes (groups) are usually set in units of vehicles, a vehicle can easily be a choice by this technology).

Further, the above embodiment has been described in connection with the example in which one element is selected from an element choice list. However, not one element but two or more elements may be selected from an element choice list and used for rendering.

For example, let us assume that ten lights (light sources) are included in CG description data, one of them corresponds to sunlight, and the remaining nine lights are expressed as artificial lights (streetlights or headlights of vehicles). Among the artificial lights, five lights are included in an element choice list. Then, five on/off switches are provided as the selection manipulating unit, and a manipulation is made by the five on/off switches. As a result, among the five artificial lights, an arbitrary number of artificial lights can be subjected to rendering.

Selection of elements to be included in a choice list is performed as “preparation work,” and so an image can be changed in real time by manipulating the selection manipulating unit during live broadcasting using a CG image. This is similarly applied to cases other than light.

Further, since one camera is typically used on one image, a plurality of cameras are unlikely to be selected. However, when a plurality of cameras are selected, a plurality of cameras may be selected in a structure in which images obtained by respective cameras, that is, images obtained by performing rendering on respective cameras, are superimposed on one another and then output as one image.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An image processing apparatus including:

a list storage unit that stores an element choice list designating a plurality of elements among elements included in computer graphics (CG) description data;

a selection manipulating unit that receives a manipulation of selecting an element from the element choice list; and

an image generating unit that generates a CG image based on the CG description data,

wherein the image generating unit excludes one or more elements other than the element selected by the selection manipulating unit from among the plurality of elements designated by the element choice list stored in the list storage unit from the CG description data, and generates a CG image.

(2)

The image processing apparatus according to (1), wherein the image generating unit includes:

a working storage unit in which the CG description data is developed to be used for image generation; and

an update control unit that erases or invalidates, in the working storage unit, one or more elements other than the element selected by the selection manipulating unit from among the plurality of elements designated by the element choice list stored in the list storage unit, and

the image generating unit generates a CG image based on content of the working storage unit.

(3)

The image processing apparatus according to (1) or (2), wherein the element is a virtual object.

(4)

The image processing apparatus according to (1) or (2), wherein the element is a virtual camera.

(5)

The image processing apparatus according to (1) or (2), wherein the element is a virtual light.

(6)

The image processing apparatus according to (1) or (2), wherein the element is a virtual force field.

(7)

The image processing apparatus according to (1) or (2), wherein the element is a virtual wind.

(8)

The image processing apparatus according to any one of (1) to (7), wherein the CG description data includes the element in a tree structure, and the image processing apparatus further comprises a list generating unit that receives a manipulation designating a node in the tree structure and generates the element choice list including a plurality of elements present below the node.

(9)

A method of generating an image, including:

selecting an element from an element choice list designating a plurality of elements among elements included in computer graphics (CG) description data; and

excluding one or more elements other than the element selected in the selecting of the element from the CG description data and generating a CG image.

(10)

A program causing a computer to function as:

a list storage unit that stores an element choice list designating a plurality of elements among elements included in computer graphics (CG) description data; and

an image generating unit that excludes one or more elements other than the element selected from among the plurality of elements designated by the element choice list stored in the list storage unit from the CG description data and generates a CG image.

(11)

An image processing apparatus including:

a switcher;

a list storage unit that stores an element choice list designating a plurality of elements among elements included in computer graphics (CG) description data; and

an image generating unit that generates a CG image based on the CG description data,

wherein a specific input bus among a plurality of input buses of the switcher receives an output of the image generating unit,

a button array of an input selection manipulating unit of the switcher includes a plurality of buttons that commonly select the specific input bus and correspond to the plurality of elements designated by the element choice list, respectively, and

when any one of the plurality of buttons is pressed, the image generating unit excludes one or more elements other than an element corresponding to the pressed button from among the elements designated by the element choice list stored in the list storage unit from the CG description data, and generates a CG image.

The present application contains subject matter related to that disclosed in Japanese Priority Patent Application JP 2011-084847 filed in the Japan Patent Office on Apr. 6, 2011, the entire content of which is hereby incorporated by reference.

What is claimed is:

1. An image processing apparatus comprising:
a list storage unit that stores an element choice list designating a plurality of elements among elements included in computer graphics (CG) description data;
a selection manipulating unit that receives a manipulation of selecting an element from the element choice list; and
an image generating unit that generates a CG image based on the CG description data,
wherein the image generating unit excludes one or more elements other than the element selected by the selection manipulating unit from among the plurality of elements designated by the element choice list stored in the list storage unit from the CG description data, and generates a CG image.

2. The image processing apparatus according to claim 1, wherein the image generating unit includes:
a working storage unit in which the CG description data is developed to be used for image generation; and
an update control unit that erases or invalidates, in the working storage unit, one or more elements other than the element selected by the selection manipulating unit from among the plurality of elements designated by the element choice list stored in the list storage unit, and
the image generating unit generates a CG image based on content of the working storage unit.

3. The image processing apparatus according to claim 1, wherein the element is a virtual object.

4. The image processing apparatus according to claim 1, wherein the element is a virtual camera.

5. The image processing apparatus according to claim 1, wherein the element is a virtual light.

6. The image processing apparatus according to claim 1, wherein the element is a virtual force field.

7. The image processing apparatus according to claim 1, wherein the element is a virtual wind.

8. The image processing apparatus according to claim 1, wherein the CG description data includes the element in a tree structure, and the image processing apparatus further comprises a list generating unit that receives a manipulation designating a node in the tree structure and generates the element choice list including a plurality of elements present below the node.

9. A method of generating an image, comprising:
selecting an element from an element choice list designating a plurality of elements among elements included in computer graphics (CG) description data; and
excluding one or more elements other than the element selected in the selecting of the element from the CG description data and generating a CG image.

10. A program causing a computer to function as:
a list storage unit that stores an element choice list designating a plurality of elements among elements included in computer graphics (CG) description data; and
an image generating unit that excludes one or more elements other than the element selected from among the plurality of elements designated by the element choice list stored in the list storage unit from the CG description data and generates a CG image.

11. An image processing apparatus comprising:
a switcher;
a list storage unit that stores an element choice list designating a plurality of elements among elements included in computer graphics (CG) description data; and
an image generating unit that generates a CG image based on the CG description data,
wherein a specific input bus among a plurality of input buses of the switcher receives an output of the image generating unit,
a button array of an input selection manipulating unit of the switcher includes a plurality of buttons that commonly select the specific input bus and correspond to the plurality of elements designated by the element choice list, respectively, and
when any one of the plurality of buttons is pressed, the image generating unit excludes one or more elements other than an element corresponding to the pressed button from among the elements designated by the element choice list stored in the list storage unit from the CG description data, and generates a CG image.
